(19) United States
(12) Patent Application Publication
(10) Pub. No.: US 2012/0297547 A1
(43) Pub. Date: Nov. 29, 2012

(54) Multi-Needle Quilting Tape Guide Apparatus and Method

(75) Inventors: Terrance L. Myers, Joplin, MO (US); David K. Winton, Jasper, MO (US); John A. Garrett, Carthage, MO (US)

(73) Assignee: L&P PROPERTY MANAGEMENT COMPANY, South Gate, CA (US)

(21) Appl. No.: 13/474,247

(22) Filed: May 17, 2012

Related U.S. Application Data
(60) Provisional application No. 61/488,844, filed on May 23, 2011.

(51) Int. Cl. A47C 17/86; B32B 7/08; D05B 11/00

(52) U.S. Cl. 5/737; 112/117; 112/475.08; 112/440

(57) ABSTRACT

A multi-needle quilting machine (20) is provided with a tape or ribbon guide (30) that is operated by a method by which a narrow strip (32) is fed against a facing layer (11a) of a wide multi-layered material (24) as it is fed into the quilting machine. In the quilting machine (20), series of chain stitches are sewn, at least one of which joins the tape (32) and layers of the multi-layered material (24) together with the same thread in a quilting process, thereby applying the tape (32) to the quilted product in a single quilting operation without the need for a post-quilting tape application step. The tape may form a decorative strip or have unsewn sections that serve as handles for a mattress when the quilted product is formed into a mattress cover.

### CROSS REFERENCE TO RELATED APPLICATIONS

The present application claims the filing benefit of U.S. Provisional Application Ser. No. 61/488,844, filed May 23, 2011, the disclosure of which is incorporated herein by reference in its entirety.

### FIELD OF THE INVENTION

The present invention relates to the application of tape strips to quilted material and, particularly to the methods and devices for applying such tapes as decorative strips or handles to quilted mattress covers.

### BACKGROUND OF THE INVENTION

Mattress covers are typically formed of panels of quilted material. Typically, rectangular top and bottom panels are joined around their edges by a border panel strip around the edges of a spring or foam mattress interior to form the outer covering of the mattress. Handles are often added to the mattress edges to facilitate the turning or other handling of the mattress. These handles have been added to the border panels, which are usually quilted, in a manufacturing step that occurs subsequent to any quilting process, typically before the border panel is joined to the other panels to cover the mattress.

The application of tape strips by a post-quilting sewing step has been proposed for the addition of handles to mattresses. Tape strips have also been sewn to quilted mattress panels for decorative purposes or functional or structural purposes in foaming mattress covers.

All such post-quilting steps involve some production time and add to production costs.

### SUMMARY OF THE INVENTION

Primary objectives of the present invention are to simplify the mattress or other quilt production costs when tape or other material strips are to be applied to the quilted product and to reduce the costs of such production processes.

According to principles of the present invention, tape or other material strips are joined to a quilted product in the quilting process. In particular, according to embodiments of the invention, tape is applied to a mattress border panel during the border quilting process on a multi-needle quilting machine.

In the illustrated embodiments of the invention, a multi-needle quilting machine is provided with a tape guiding device that feeds a tape strip against a facing sheet of a material being quilted in the quilting machine. In the quilting machine, one or more of the series of stitches of quilting patterns that is sewn to join the layers of quilted material is also directed to attach the fed tape strip to the face of the fabric.

In particular embodiments of the invention, the stitches of the quilted pattern join a tape strip to a mattress border panel. In certain embodiments, a continuous series of stitches of the pattern joins the tape strip along sections of the length of the strip with the stitch sequences tacked at one or both ends. Then a section of the tape strip is skipped or jumped over and sewn again at a length along the strip, eight or twelve inches long, for example, to allow the tape strip in between the sewn portions of the strip to serve as a handle.

With the invention, a quilt, such as a mattress border panel, a mattress cover formed of the border panel, and a mattress are provided having tape or ribbon strips secured by the same stitches that join layers of the quilted material together. More particularly, such panels, mattress covers and mattresses are provided having handles secured by chain stitch pattern sequences that join multiple layers of quilted material together. These layers typically have a facing layer, a backing layer, a fill layer between the facing and backing layers, and a tape strip secured to the outside of the facing layer, all held together with the same chain-stitched quilted patterns.

The invention eliminates separate sewing processes or steps to apply tape to quilts, and particularly, to apply handles to border panels, mattress covers or mattresses. With the invention, mattress cover or other quilt manufacturing processes are simplified and their costs are reduced.

These and other objects and advantages of the present invention will be apparent from the following detailed description of the embodiments which are illustrated in the drawings, in which:

### BRIEF DESCRIPTION OF THE DRAWINGS

FIG. 1A illustrates a length of quilted mattress border panel of the prior art having mattress handles secured thereto.

FIG. 1B illustrates a length of quilted mattress border panel of the prior art having a tape strip sewn thereto to form mattress handles along the border panel.

FIGS. 2A, 2B, and 2C are drawings illustrating lengths of quilted mattress border panels according to embodiments of the present invention in which the same quilting stitch sequences applied in the quilting process to attach the layers of the quilted material together also secure the tape or ribbon to the border panels to form decorative strips or mattress handles.

FIG. 3 is an isometric diagram depicting a multi-needle quilting machine having structure attached thereto for applying tape or ribbon to form the quilted products of FIGS. 2A to 2C during the quilting process according to principles of the present invention.

FIG. 4 is a perspective view of a tape guide attachment portion of a quilting machine according to the diagram of FIG. 3.

FIG. 5 is a front perspective view of a quilting machine of FIGS. 3 and 4.

### DETAILED DESCRIPTION OF THE DRAWINGS

In the detailed description below, parts identified by a common number followed by a letter to distinguish multiple similar ones of such parts may be referred to as a group by the number alone. For example, border panel 10 may refer to border panels 10a, 10b, . . . .

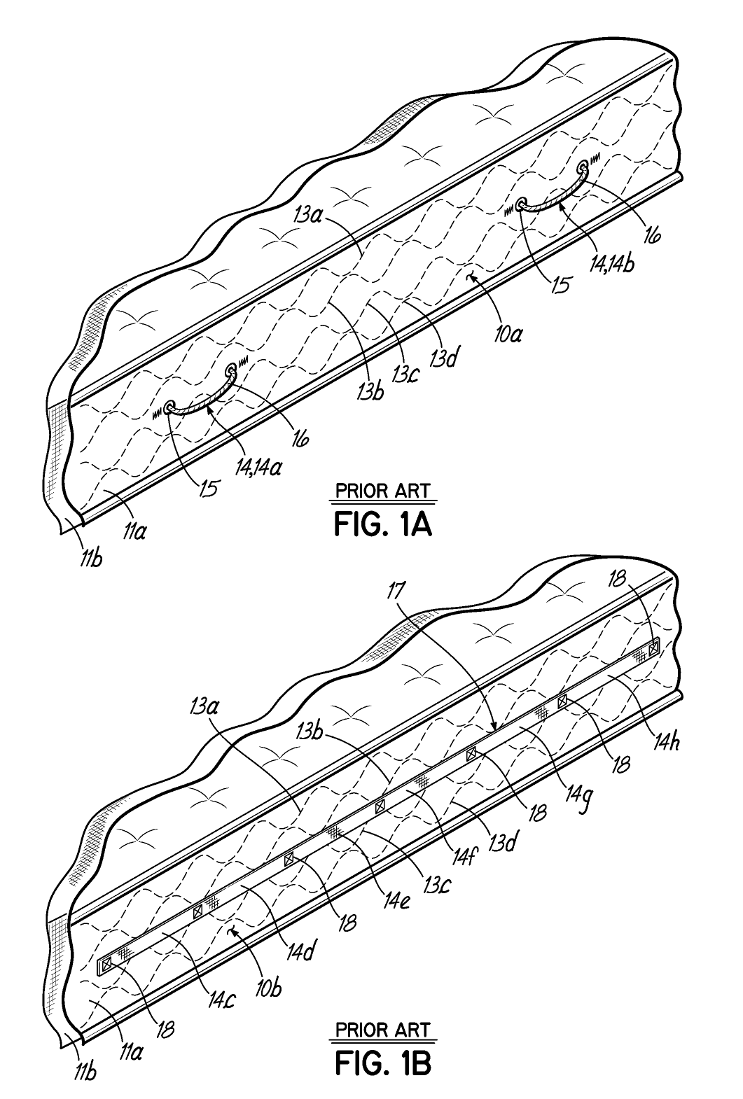

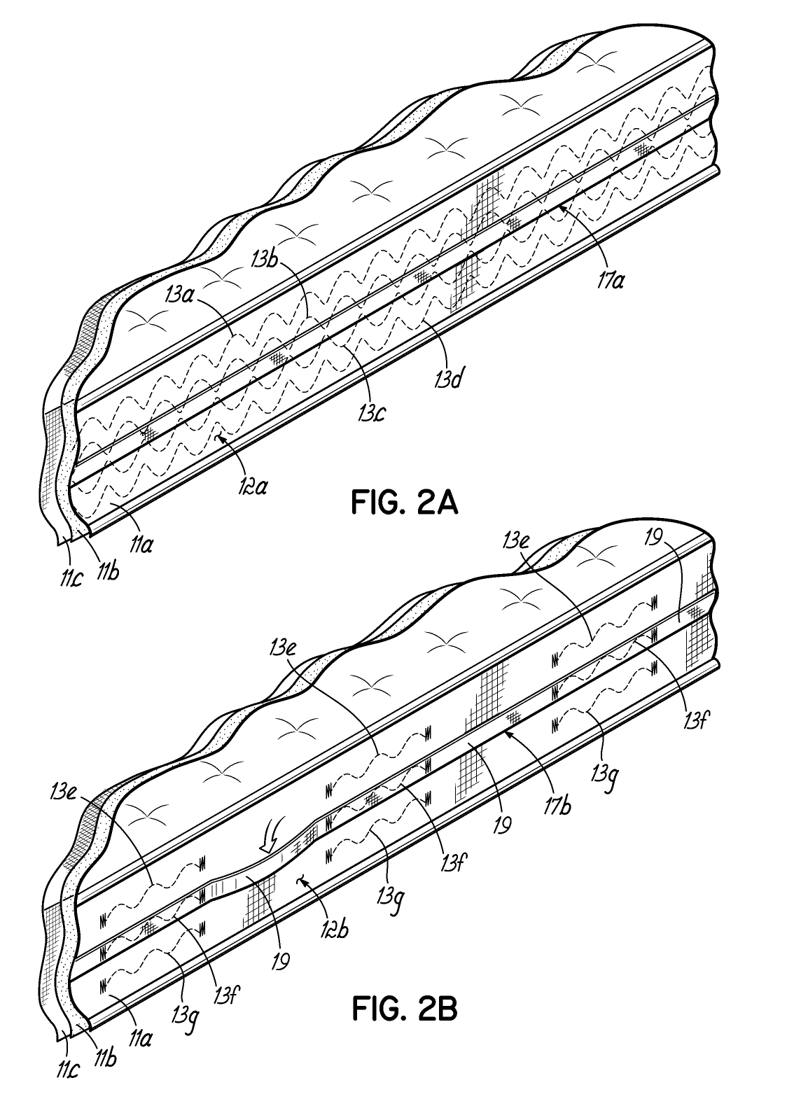

FIG. 1A shows a mattress border panel 10a of the prior art formed of multiple layers of material 11a and 11b that have been sewn together with sequences of stitches 13a, 13b, 13c, 13d in a quilting process. The border panel 10a also has handles 14 (14a, 14b) attached thereto in a subsequent manufacturing step, using grommets 15 and cord 16 secured in a separate post-quilting process.

FIG. 1B shows another mattress border panel 10b of the prior art formed of multiple layers of material 11a and 11b that have been sewn together with sequences of stitches 13a, 13b, 13c, 13d in a quilting process. The border panel 10b also has a tape or ribbon strip 17 sewn to the quilted fabric on a separate single needle quilting machine after the quilted border panel has been removed from the quilting machine. The strip 17 is attached to the quilted fabric by the application of stitch blocks 18. The sections of the tape or strip 17 between the stitch blocks 18 form handles 14 (14c, . . . , 14h) attached thereto in a subsequent manufacturing step. The stitch blocks 18 are lock-stitch sequences sewn on a traditional lock-stitch, single-needle, handle sewing machine.

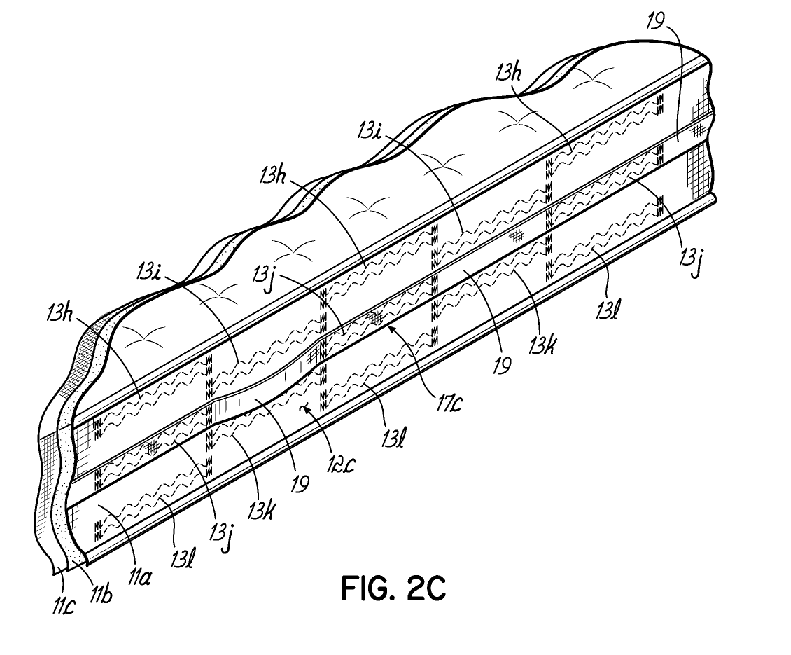

FIG. 2A illustrates one embodiment of a mattress border panel 12a formed of multiple layers of material 11a, 11b and 11c according to principles of the present invention. The layers of material include a facing layer 11a, a backing layer 11c and one or more fill layers 11b that have been sewn together with sequences of stitches 13a, 13b, 13c, 13d in a quilting process on a multi-needle quilting machine. The border panel 12a also has a tape or ribbon strip 17a sewn to the quilted fabric with the same sequences of stitches 13a, 13b, 13c, 13d that joined the layers of material 11a, 11b, and 11c in the quilting process on the multi-needle quilting machine. The strip 17a, as shown, is attached to the quilted fabric by the application of the continuous stitch sequences 13b and 13c that overlap onto the strip 17a. So sewn, the strip 17a can form a decorative strip on a mattress cover or other quilted panel secured to the top of the facing layer 11a with some of the same stitch sequences, namely 13b and 13c, that secure the layers 11a, 11b and 11c of the quilted panel 12a together.

FIG. 2B illustrates another embodiment of a mattress border panel 12b formed of multiple layers of material 11a, 11b and 11c according to principles of the present invention. The layers of material include facing layer 11a, backing layer 11c and one or more fill layers 11b all sewn together with TACK AND JUMP™ intermittent series of stitch sequences 13e, 13f, 13g in a quilting process on a multi-needle quilting machine. The border panel 12b also has a tape or ribbon strip 17b sewn to the quilted fabric with one of the same sequences of stitches 13e, 13f, 13g, namely, the center sequence 13f that joined the layers of material 11a, 11b and 11c in the quilting process on the multi-needle quilting machine. The strip 17b, as shown, is attached to the quilted fabric by the application of the series of sequences of stitches 13f that form a tack at each end and spaced from each other along the length of the strip 17b, leaving a section of unstitched tape or ribbon to form handles 19 that serve as handles for a mattress when the panel 12b is sewn to top and bottom panels to form a mattress cover. Each of the series of chain stitch sequences are formed by a needle thread on the facing layer side of the multilayered material and a looper thread on the opposite side of the material, with at least the needle thread being cut between the sequences.

A further embodiment of a mattress border panel 12c, formed of multiple layers of material 11a, 11b and 11c, according to principles of the present invention, is illustrated in FIG. 2C. The layers of material include facing layer 11a, backing layer 11c and one or more fill layers 11b sewn together with TACK AND JUMP™ intermittent series of stitch sequence pairs 13h, 13i, 13j, 13k, 13l sewn simultaneously with multiple staggered rows of needles, in a quilting process on a multi-needle quilting machine. The border panel 12c has a tape or ribbon strip 17c sewn to the quilted fabric with one of the same sequence pairs 13h, 13i, 13j, 13k, 13l, namely, the center sequence pair 13j that joined the layers of material 11a, 11b and 11c in the quilting process on the multi-needle quilting machine. The strip 17c, as shown, is attached to the quilted fabric by the application of the series of sequence pair 13j tacked at each end and spaced from each other along the length of the strip 17c, leaving a section of unstitched tape or ribbon to form handles 19 that serve as handles for a mattress when the panel 12c is sewn to top and bottom panels to form a mattress cover.

The strips are generally narrow relative to the widths of the web layers of the material 11 to which they are attached. Where the border panels are, for example, 8 to 16 inches wide, the strips are typically ¾ to 2 inches wide.

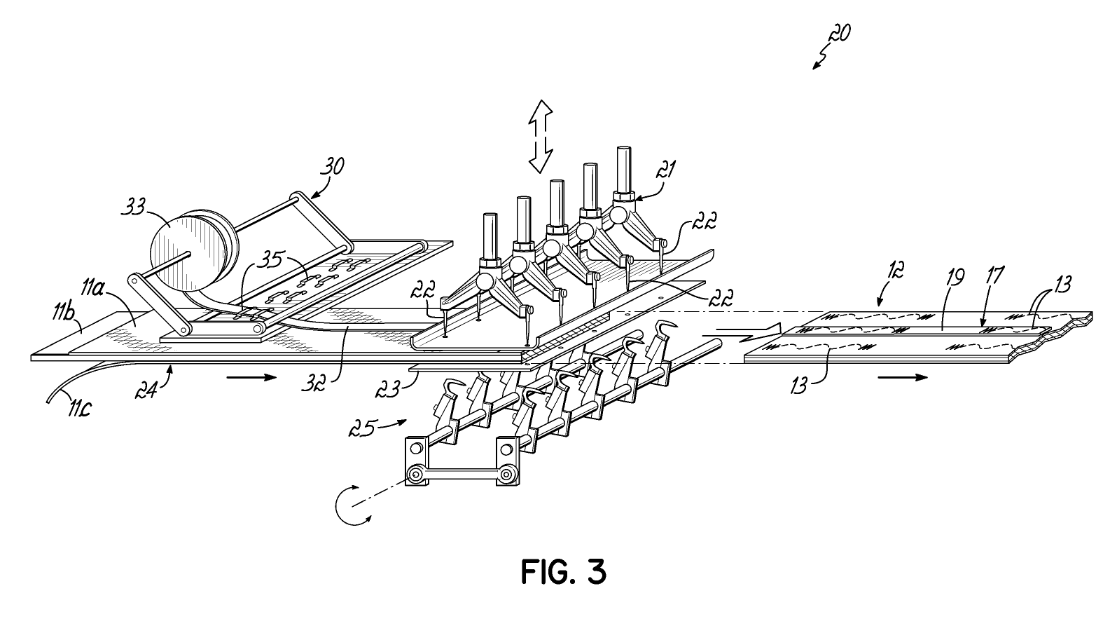

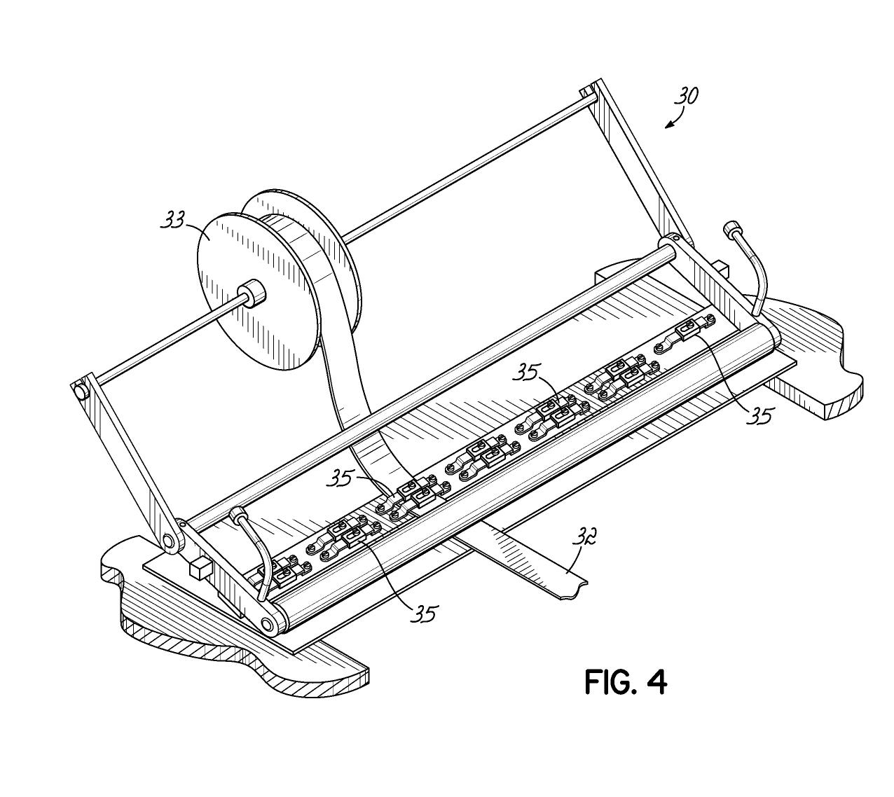

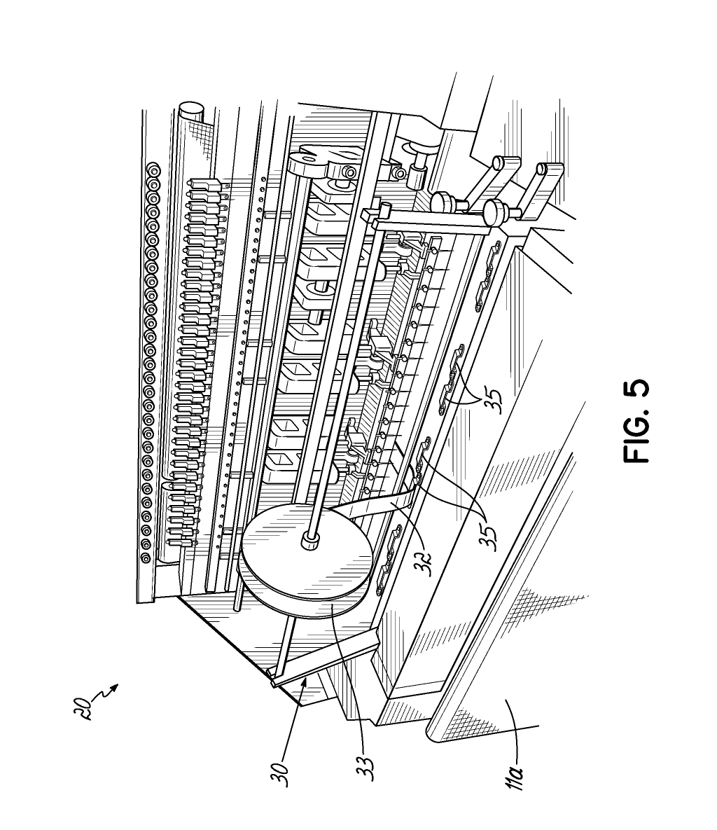

The border panels 12a, 12b and 12c of FIGS. 2A, 2B and 2C are sewn in a border panel quilting process performed on a multi-needle quilting machine, such as machine 20 illustrated in FIGS. 3, 4 and 5. The quilting machine 20 has a frame 21 on which is mounted a plurality of rows of needles 22 that reciprocate through a needle plate 23 that supports a web of multi-layered material 24 for quilting. Below the needle plate are a plurality of rows of loopers 25 (shown in FIG. 3) that correspond to the needles 22 and operate to form a plurality of chain stitch sequences in the material 24 during a quilting process. The machine 20 in the illustrated embodiment is a narrower version of a wide format quilter that is used to quilt top and bottom panels of a mattress. The quilting machine 20 is provided for sewing border panels, such as the panels 12a, 12b and 12c of FIGS. 2A, 2B and 2C. Such panels may be sewn individually or in groups of two or three arranged side-by-side.

According to certain principles of the present invention, the machine 20 is provided with a tape guide attachment 30 across the front thereof to feed one or more rolls of tape or ribbon 32 into the machine 20 to be sewn against the layer of facing material 11a during quilting. The ribbon 32 is fed from a spool 33 rotatably supported on a transverse shaft that extends across the front of the machine 20. The ribbon or tape 32 is fed from the spool 33 through a tension device 35 and into the machine 20 on the top of the layer of facing material 11a. In the machine 20, chain stitch sequences 13 are sewn with the simultaneous operation of the needle drive 21 and looper drive 25 to join the layers 11a, 11b and 11c together and, at the same time and with some of the same stitch sequences 13 to sew the tape or ribbon 17 to the facing layer 11a. As shown in FIG. 3, using the patterns described in connection with the description of the panel 12b of FIG. 2B, handles 19 can be formed of the tape 17.

Although only certain exemplary embodiments of this invention have been described in detail above, those skilled in the art will readily appreciate that various modifications can be made without departing from the principles of the present invention. Accordingly, all such modifications are intended to be included within the scope of this invention.

What is claimed is:

1. A multi-needle quilting machine comprising:
a needle plate to support a web of multi-layered material for quilting;
a plurality of needles arranged in an array supported on one side of the needle plate;
a corresponding plurality of loopers arranged in a corresponding array supported on the opposite side of the needle plate from that on which the needles are supported;
a web feed assembly operative to feed a plurality of web layers of material onto the needle plate and between the needles and loopers;
a needle drive assembly operable to reciprocate the needles simultaneously through a multi-layered material supported by the needle plate assembly;
a looper drive assembly operable to oscillate the loopers simultaneously in a chain stitch forming relationship with the needles on the side of the needle plate assembly on which the loopers are supported; and
a tape guide assembly configured to support one or more webs of tape and to feed the one or more webs of tape with the web layers of material between the needles and loopers to be quilted together with the web layers of material by said chain stitch sequences that join the web layers together to form a quilt.

2. The quilting machine of claim 1 wherein:
the tape guide assembly further comprises a tape tension device positioned such that the tape can be fed through the tension device before being fed between the needles and loopers.

3. A method of forming a mattress cover border panel comprising:
feeding a narrow strip of material into a quilting machine against a wide web of multi-layered material being quilted in the machine, wherein the narrow strip of material is narrower than the wide web of multi-layered material; and
in the machine, quilting layers of the multi-layered material together with one or more series of chain stitches, at least one of the one or more series joining the narrow strip and the layers of the wide web together.

4. The method of claim 3 wherein:
the quilting includes sewing the one or more series of chain stitches such that said at least one of which is sewn in a series of stitch sequences, a first sequence of which ends in a tack sewn in the narrow strip and a second sequence of which begins in the narrow strip at a distance spaced from the tack with a needle thread of which the tack is formed being cut between said first and second sequences.

5. The method of claim 3 wherein:
the quilting includes sewing the one or more series of chain stitches such that said at least one of the series is sewn in a series of at least three stitch sequences, a first and a second of which each end in a tack in the narrow strip and at least two of which each begin in the narrow strip at distances spaced from different ones of the tacks with a needle thread of which the tack is formed being cut between sequences of the series, with the narrow strip forming a handle between a tack and the beginning of a sequence of the series.

6. A mattress cover border panel made according to the method of claim 5.

7. A mattress cover border panel made according to the method of claim 4.

8. A mattress cover border panel made according to the method of claim 3.

9. A mattress cover border panel section comprising:
a facing layer of material;
one or more backing layers or fill layers of material;
a tape strip on a side of the facing layer that is opposite a backing layer or fill layer; and
one or more series of chain stitches, each securing the facing layer and each of the backing layers or fill layers together, at least one of the series also securing the facing layer, each of the backing layers or fill layers, and the tape strip together.

10. The mattress cover border panel section of claim 9 wherein:
the at least one of the series of chain stitches that secure the facing layer, each of the backing layers or fill layers, and the tape strip together are sewn in a series of at least two stitch sequences between which at least a needle thread of which the sequences are formed is cut, a first of the at least two stitch sequences ending in a tack, and a second beginning along the tape spaced at a distance from the tack; and
the tape between the tack and the beginning of the second stitch sequence forms a mattress handle.

11. The mattress cover border panel section of claim 10 wherein:
the one or more series of chain stitches that secure the facing layer, each of the backing layers or fill layers, and the tape strip together are sewn in a series of at least three stitch sequences at the end of each of at least two of which is sewn a tack, after which tack at least a needle thread of which the tack is formed is cut, another one of the stitch sequences beginning along the tape spaced at a distance from the tack, so that the tape between the tack and said beginning forms a mattress handle;
whereby at least two mattress handles are formed by the tape along the border panel section.

12. The mattress cover border panel section of claim 11 further comprising a tack at the beginning of each stitch sequence.

13. A rectangular mattress comprising one or more border panels formed of two border panel sections of claim 12, the mattress further comprising:
an interior having a top, a bottom, two side edges, and two end edges;
a top panel on said top of the interior;
a bottom panel on said bottom of the interior; and
the one or more border panels joining the top and bottom panels and surrounding the edges, each of the two border panel sections being on one of the side edges of the interior;
the panels forming a mattress cover surrounding the interior and having at least two mattress handles along each of said side edges.

14. The mattress of claim 13 wherein the border panel sections further include a tack at the beginning of each stitch sequence.

15. A rectangular mattress comprising one or more border panels formed of two border panel sections of claim 11, the mattress further comprising:
an interior having a top, a bottom, two side edges, and two end edges;
a top panel on said top of the interior;
a bottom panel on said bottom of the interior; and
the one or more border panels joining the top and bottom panels and surrounding the edges, each of the two border panel sections being on one of the side edges of the interior;
the panels forming a mattress cover surrounding the interior and having at least two mattress handles along each of said side edges.

16. A rectangular mattress comprising one or more border panels formed of two border panel sections of claim 9, the mattress further comprising:
an interior having a top, a bottom, two side edges, and two end edges;
a top panel on said top of the interior;
a bottom panel on said bottom of the interior; and
the one or more border panels joining the top and bottom panels and surrounding the edges, each of the two border panel sections being on one of the side edges of the interior;
the panels forming a mattress cover surrounding the interior and having at least two mattress handles along each of said side edges.

17. A rectangular mattress comprising one or more border panels of claim 6, the mattress further comprising:
an interior having a top, a bottom, two side edges, and two end edges;
a top panel on said top of the interior;
a bottom panel on said bottom of the interior; and
the one or more border panels joining the top and bottom panels and surrounding the edges;
the panels forming a mattress cover surrounding the interior.

18. A rectangular mattress comprising one or more border panels of claim 5, the mattress further comprising:
an interior having a top, a bottom, two side edges, and two end edges;
a top panel on said top of the interior;
a bottom panel on said bottom of the interior; and
the one or more border panels joining the top and bottom panels and surrounding the edges;
the panels forming a mattress cover surrounding the interior.

19. A rectangular mattress comprising one or more border panels of claim 4, the mattress further comprising:
an interior having a top, a bottom, two side edges, and two end edges;
a top panel on said top of the interior;
a bottom panel on said bottom of the interior; and
the one or more border panels joining the top and bottom panels and surrounding the edges with the handles being on one of the side edges of the interior;
the panels forming a mattress cover surrounding the interior and having at least two mattress handles along each of said side edges.
